(19) United States
(12) Patent Application Publication
(10) Pub. No.: US 2023/0362287 A1
(43) Pub. Date: Nov. 9, 2023

(54) COLLAPSIBLE ERGONOMIC ACCESSORY FOR A HANDHELD MOBILE DEVICE

(71) Applicant: Travis Fowler, Tamarac, FL (US)

(72) Inventor: Travis Fowler, Tamarac, FL (US)

(21) Appl. No.: 17/736,875

(22) Filed: May 4, 2022

(51) Int. Cl. F16M 13/04; F16M 13/06; H04M 1/04

(52) U.S. Cl. CPC H04M 1/04; F16M 13/04; F16M 13/06

(57) ABSTRACT

A collapsible ergonomic accessory for attachment to a handheld electronic device, comprising a mountable base, an adhesive element affixed to an underside of said base, a support stand pivotally connected to said mountable base by a hinge element, and an ergonomic brace element at a distal end of said support stand. The ergonomic brace element defines a semi-circular arch configured to engage with a user’s finger. The adhesive element couples said mountable base to a rear surface of a handheld electronic device. The accessory has a concentric geometry of the collapsible ergonomic accessory, wherein the components of the accessory are nested into a substantially flat form factor. The brace element rotates inward and outward from the top of the support stand, which may be a ring.

### FIELD OF INVENTION

The invention relates generally to support devices for handheld electronics including mobile devices, such as mobile phones, tablet computers, or the like. More particularly, it relates to adhesive finger engageable support and kickstands for handheld electronics that adheres to the rear surface of a mobile device or case of a mobile device and provide a pivotable member to prop the mobile device up.

### BACKGROUND

Over the years mobile devices, like cellular telephones, PDSs, and handheld portable electronics have decreased in size from the initial large form factors when each was invented. However, after color screens were introduced on cellular phones, screens began to increase in size as the demand for more viewable space increased. With the advent of smartphones, screen sizes increased beyond the comfortable form factor users were used to holding, with many reaching over six inches diagonally.

This has increased the width of the phone to something less ergonomic leaving many users to support the base of the mobile phone with his or her pinky finger. This means of support has largely resulted in what is informally referred to as “smartphone pinky” to categorize the injuries that can result from overusing the pinky finger to support the weight of a smartphone. Like the free end of a cantilever, pressure placed towards the tip of the pinky will bend the pinky finger, which may strain the finger.

Other products have been invented to attempt to solve this problem, however, such inventions typically situate themselves between two of a user’s fingers, but still puts pressure towards the tip of a user’s finger, which shifts the strain to a different finger. Therefore, there currently exists a need in the industry for a device that allows the user to comfortably use their mobile phone for long periods of time without having to deal with the discomfort caused by strain on the pinky finger.

### SUMMARY OF THE INVENTION

Provided is a collapsible ergonomic accessory for attachment to a handheld electronic device, comprising a mountable base, an adhesive element affixed to an underside of said base, a support stand pivotally connected to said mountable base by a hinge element, and an ergonomic brace element at a distal end of said support stand. The ergonomic brace element defines a semi-circular arch configured to engage with a user’s finger. The adhesive element couples said mountable base to a rear surface of a handheld electronic device.

Further provided is a concentric geometry of the collapsible ergonomic accessory, wherein the components of the accessory are nested into a substantially flat form factor. The brace element rotates inward and outward from the top of the support stand, which may be a ring.

It is an object of the invention to provide a phone stand that can alleviate the pressure on the pinky finger from supporting the weight of an electronic device, such as a smart phone.

It is a further object of the invention to have a device that can collapse into a nested state to provide a compact form factor that is on obtrusive.

It is yet further an object to have a device that is capable of providing both a stand for a mobile device when placed on a tabletop or provide a gripping element when in a user’s hand.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates an elevational view of the accessory in a closed state with a smartphone.

FIG. 2 illustrates a perspective view of the accessory in an open state with a smartphone.

FIG. 3 illustrates a perspective view of the accessory as a kickstand with a smartphone.

FIG. 4 illustrates a perspective view of the accessory in a closed state.

FIG. 5 illustrates a perspective view of the accessory in an open state.

FIG. 6 illustrates a perspective view of the accessory in an open state with ergonomic brace extended.

FIG. 7 illustrates an exploded view of the components of the accessory.

FIG. 8 illustrates a top view of the accessory in a closed state with section cut A-A.

FIG. 9 illustrates a section cut elevation view of the accessory at cut A-A.

FIG. 10 illustrates a side view of the accessory.

### DETAILED DESCRIPTION OF THE INVENTION

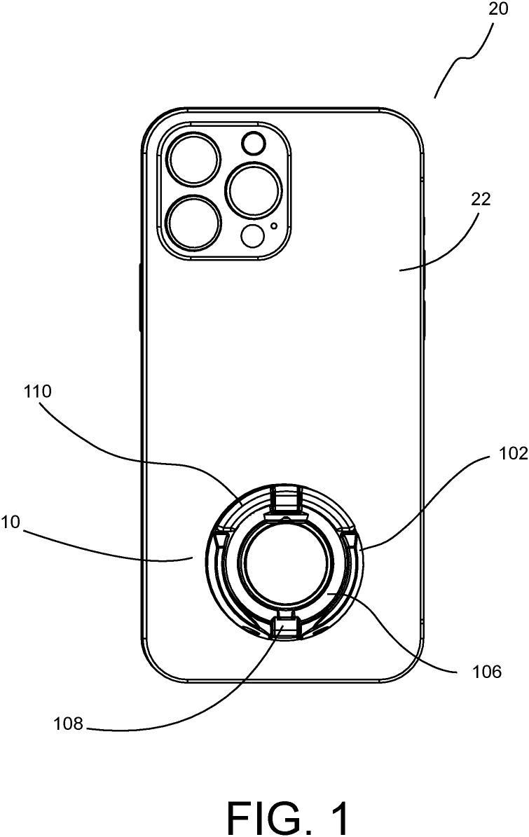

The invention provides an ergonomic solution for holding an electronic device 20 in an easy-to-use accessory 10, as shown in an exemplary embodiment in FIGS. 1-10. The device 10 allows the user to comfortably use their phone 20 for long periods of time without having to deal with ‘smartphone pinky syndrome’, or any uncomfortable strain on their pinky for excessive use of one’s phone 20. The product can also be folded out into a phone 20 stand for optimal viewing.

The accessory is designed to provide cushion for a user’s pinky finger at the bottom of a phone. It is also designed to have a compact design so that the accessory is not bulky, which allows a wider variety of use and ease of transport. Further, the accessory is designed to be folded on the back of a smartphone for use as a holder accessory, but also functions as a stand.

The accessory employs an adhesive base to affix to a smartphone or similar electronic device. A stand pivots out from the base so that a user can engage with the ring component of the stand as it functions as a holding accessory, similar to the functionality of a “pop socket”. A user may also use the stand to prop the mobile device up for actions including watching movies or video calling other users.

When holding a smartphone with the accessory, the user can engage with the accessory by either by putting a finger through the ring, or by flipping down an ergonomic cushion. In order to accommodate both actions, the base of the accessory can rotate so that the orientation of the ring can be vertical to provide access within the ring for the user’s finger, or the orientation can rotate to horizontal so that the ergonomic brace can provide a cushioned support against a user’s finger.

The cushioned brace portion employs rubberized coverings that provide cushion for the finger, while the rotatability of the brace allows the semi-circular arch to rest upon the proximal phalanx of the phalange, rather than the intermediate phalanx or distal phalanx of the phalanges. The shift towards the proximal phalanx also eases the strain on the finger associated with placing excessive pressure at the distal phalanx (or tip of the pinky) associated with using the pinky as a support without a brace. The brace can rotate 360 degrees about an axis of the stand, and the lateral extensions of the brace can rotate 360 degrees about an axis perpendicular to the brace. Because of this rotation, the brace can accommodate a variety of orientation a user may feel are comfortable.

Because of the numerous rotating pieces, it is important to add in components to keep certain pieces in place, even when a heavier portion are on top. This requires an element that places friction on the components so that the weight of a component does not influence to orientation of it. This is particularly important for rotating the base and rotating the distal ends (lateral extensions) of the semi-circular brace. With regard to the rotating base, a rubber gasket may be incorporated to keep the orientation of the stand at a desired positioning. For the lateral extensions of the semi-circular brace, this is achieved through use of the rubber covers, which rub against each other and hold the positioning of the semi-circular brace.

In order to keep the design compact, the components therein are nested. That is, the semi-circular brace may fold inwards into the stand, and the stand may be folded back into the body of the mount. When folded, the accessory has a substantially uniform geometry, with the mount having semi-circular arches that surround the ring stand, a raised surface protruding in the center of the ring stand, and the ergonomic brace at the top of the ring stand completing the semi-circular arch of the body, thereby providing a substantially flat upper surface, and continuous periphery wall.

The orientation of the elements and overall construction of the accessory may be seen in the figures.

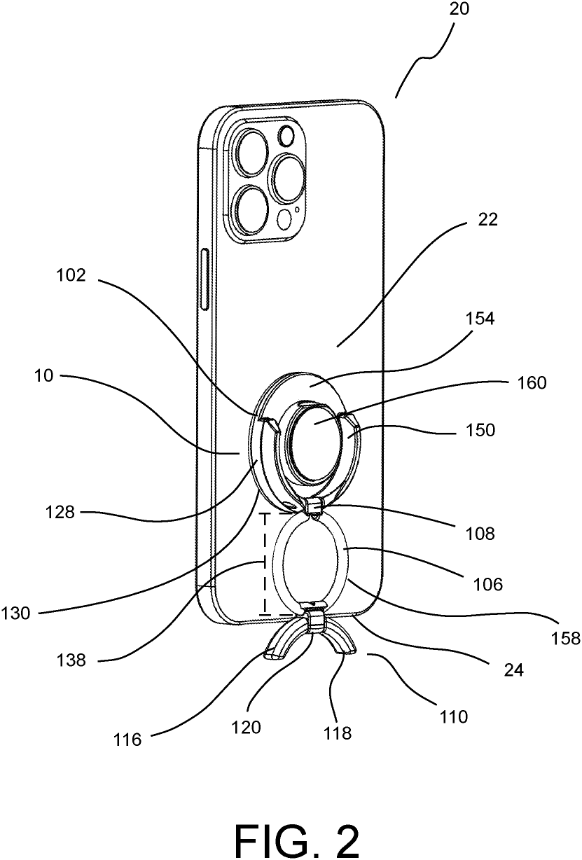

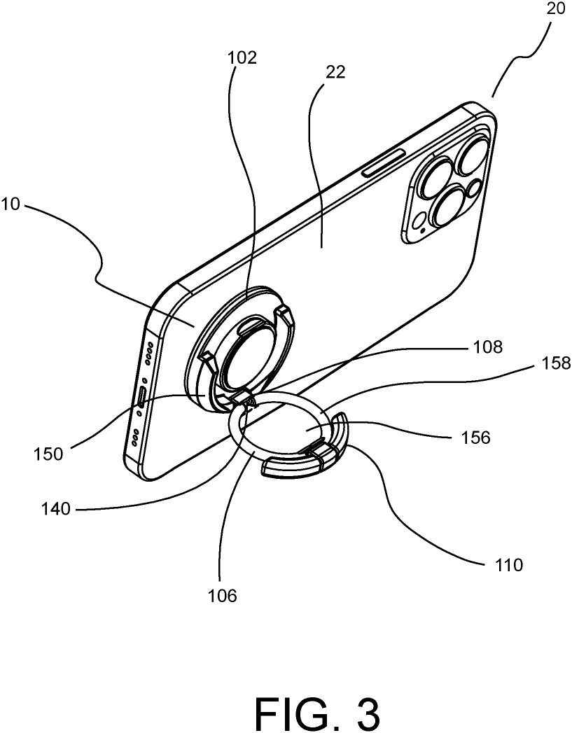

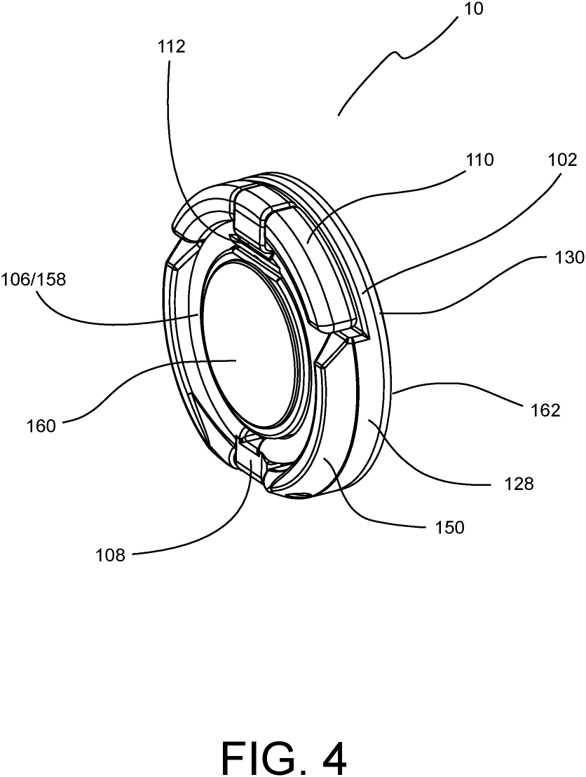

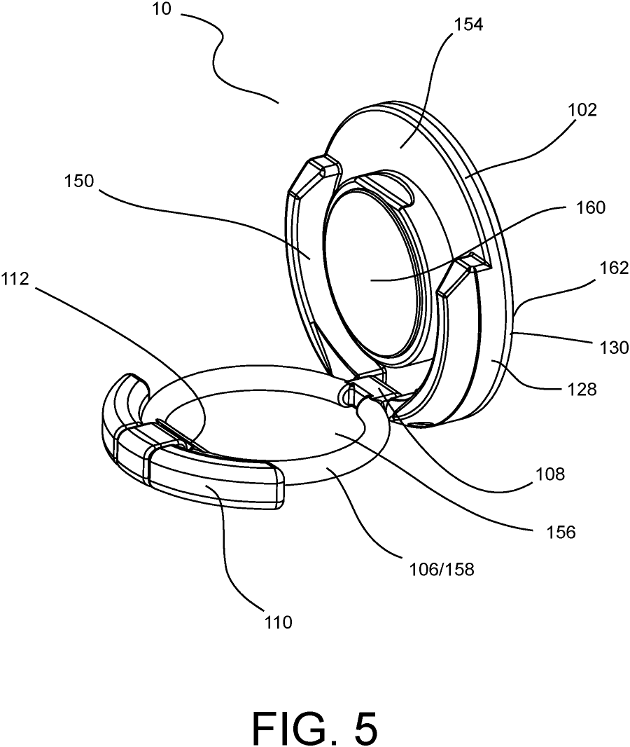

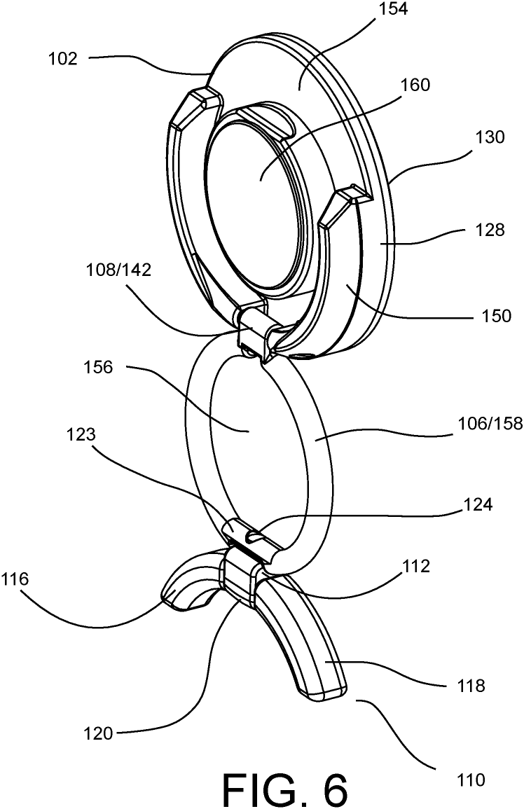

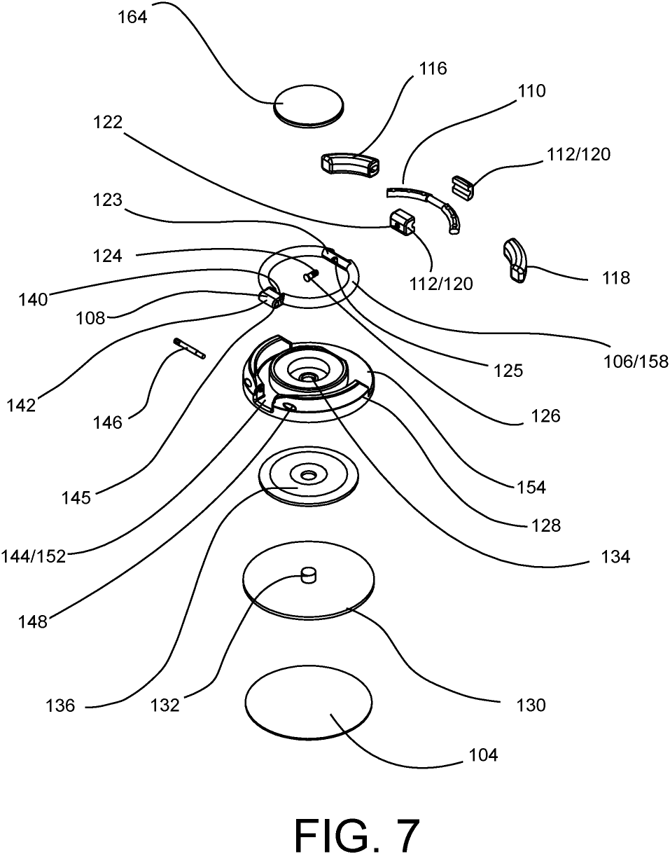

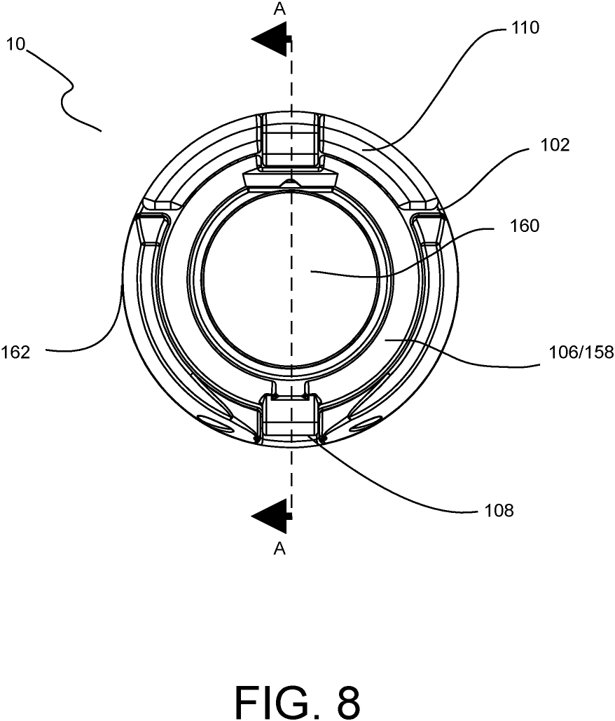

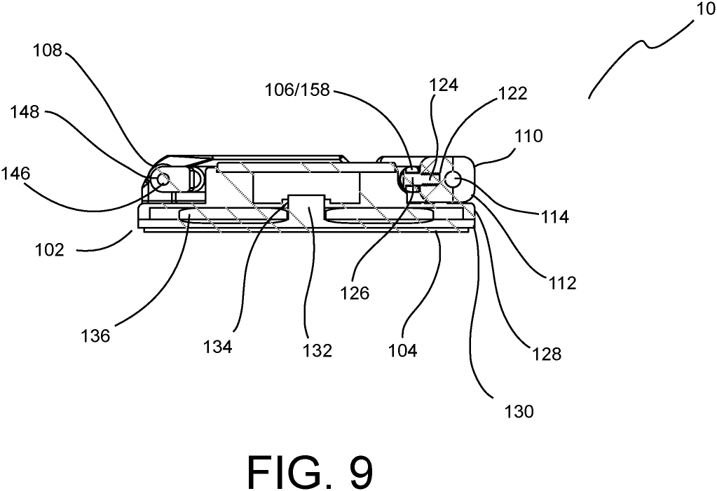

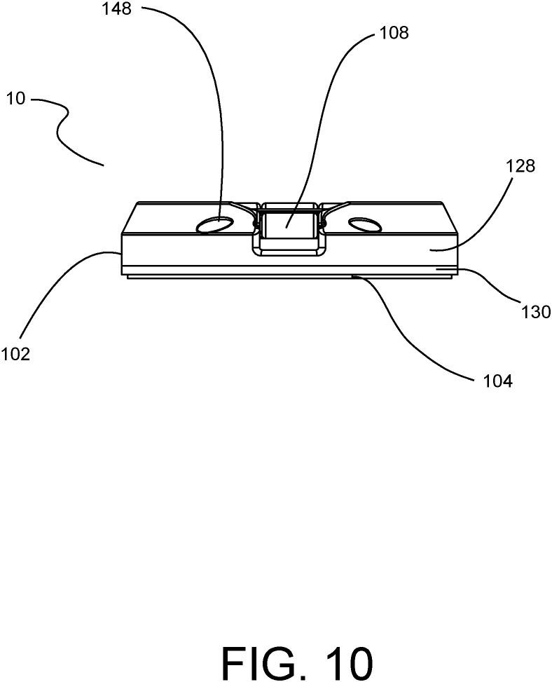

FIG. 1 illustrates an elevational view of the accessory 10 in a closed state with a smartphone 20. FIG. 2 illustrates a perspective view of the accessory 10 in an open state with a smartphone 20. FIG. 3 illustrates a perspective view of the accessory 10 as a kickstand with a smartphone 20. FIG. 4 illustrates a perspective view of the accessory 10 in a closed state. FIG. 5 illustrates a perspective view of the accessory 10 in an open state. FIG. 6 illustrates a perspective view of the accessory 10 in an open state with ergonomic brace 110 extended. FIG. 7 illustrates an exploded view of the components of the accessory 10. FIG. 8 illustrates a top view of the accessory 10 in a closed state with section cut A-A. FIG. 9 illustrates a section cut elevation view of the accessory 10 at section cut A-A. FIG. 10 illustrates a side view of the accessory 10.

In an exemplary embodiment of the invention, shown in FIGS. 1-10, a collapsible ergonomic accessory 10 for attachment to a handheld electronic device 20 is shown. The accessory 10 comprises a mountable base 102, an adhesive element 104 affixed to an underside of the base 102, a support stand 106 is pivotally connected to the mountable base 102 by a hinge element 108, and an ergonomic brace element 110 is at a distal end of the support stand 106. The ergonomic brace element 110 defines a semi-circular arch configured to engage with a user’s finger. The adhesive element 104 couples the mountable base 102 to a rear surface 22 of a handheld electronic device 20.

In some embodiments, the ergonomic brace element 110 further comprises a clamp 112 affixed to the distal end of the support stand 110. The clamp 112 pivotally captures a shaft 114 at a center point of the semi-circular ergonomic brace element 110, wherein an engagement of the clamp 112 and the shaft 114 allows rotatable movement of the semi-circular ergonomic brace 110 about an axis of the shaft 114 thereby allowing an orientation of the semi-circular ergonomic brace element 110 to be selected from a concave position, as shown in in FIG. 3 in relation to the support stand 106 or convex in relation to the support stand 106, as shown in FIG. 2. The clamp 112 and the shaft 114 are frictionally engaged resulting in a stiff rotation, thereby allowing the orientation of the semi-circular brace 110 to remain in position until changed by a user. In some embodiments, this is achieved by covering each end of the semi-circular brace 110 with a rubber sheath 116/118 and adding a rubber cover 120 to envelope the clamp 112. The combination of this covering 116/118/120 creates friction between the different covers 116/118/120 because of the proximity of the different covers 116/118/120 creating a rubbing action. This creates the frictional pressure between each rubber sheath 116/118 and the rubber cover 120, and as a result, providing frictional engagement for the semi-circular brace 110 and cushion for a user’s finger. Frictional engagement indicates the pressured engagement that keeps a component in the system in a fixed location because the tightness between the components holds each component in a specific orientation.

In some embodiments, the clamp 112 includes an aperture 122 in the clamp 112 and in a surface 123 facing the support stand 106 to complementarily engage a knob on the distal end of the support stand 106 to rotatably couple the clamp 112 to the support stand 106. However, in the exemplary embodiment, the knob is interchanged with a threaded screw 124 that threads into the clamp 112. Rotation is still achieved because of the shoulder portion 126 of the screw 124 that allows the screw 124 to rotate in the unthreaded hole 125 on the ring 158.

In some embodiments, as may be seen in FIG. 7, the mountable base 102 includes a two-part base body 102/128/130. The first part 128 in the two-part base body 102 defines a main body 128 with hinge 108 coupling to the support stand 106. A second part 130 of the two-part base body 102 defines a mounting bracket 130 with the adhesive element 104 affixed to the underside of the base. The second part 130 of the two-part base body 102 immovably affixes to the rear surface 22 of a handheld electronic device 20. Once coupled together, the first part 128 of the two-part base body 102 may rotate about a center point of the second part 130 of the two-part base body 102, thereby creating a rotatable support stand 106 for a handheld electronic device 20. Rotation is achieved by engagement of a fastening element 132 on the second part 130 that snaps into an open aperture 134 on the first part. In some embodiments, a rubber gasket 136 is included between the first part 128 and the second part 130 to provide friction and allow the stand 106 to remain in a fixed position without rotating out of place. In these embodiments, the first part 128 of the two-part base body and the second part 130 of the two-part base body are frictionally engaged by increased pressure, resulting in a stiff rotation, thereby allowing an orientation of the first part 128 of the two-part base body to remain in a position relative to the second part 130 of the two-part base body until changed by a user.

In some embodiments, the hinge element 108 of the support stand includes a male hinge component 142 of the support stand 106 engaging with a female end 144 of the mountable base 102, wherein a geometry of the male hinge component 142 of the support stand 106 puts pressure on the female end 144 of the mountable base 102, thereby providing frictional support to keep the support stand 106 in a constant position when engaged. In the exemplary embodiment, the hinge element 108 of the support stand 106 includes a male apex 142 of the support stand 106, having an open shaft 145 therein. A press-fit pin 146 inserts through the hollow shaft 145 of the male hinge component 142 at an apex of the support stand 106 so that the stand stays tight and will not move because of the frictional pressure.

In some embodiments, the components of the collapsible ergonomic accessory 10 for attachment to a handheld electronic device 20 are nested together when in a closed state, as shown primarily in FIGS. 1, 4, 8, 9, and 10. In the exemplary embodiment, a semi-circular arch 150 protrudes from a top surface 154 of the mountable base 102 a distance up equaling to the thickness of the support stand 106, which may be appreciated in the cross-sectional view of FIG. 9. The semi-circular arch 150 has a gap 152 at its apex for insertion of the hinge element 142 of the support stand 106.

In some embodiments, the support stand is a concentric ring 158 with an open interior portion 156. When this embodiment is nested, a raised circular plateau 160 raises from a center point of the top surface 154 of the mountable base 102 through the ring’s open interior 156. The support stand 106/158 is configured to nest in between the semi-circular arch 150 protruding from the top surface 154 of the mountable base 102 and the raised circular plateau 160 when the support stand 106/158 is in a closed state. The ergonomic brace element 110 is configured to nest above the support stand 106/158 with a geometry completing the raised semi-circular arch 150 protruding the top surface 154 of the mountable base 102, wherein the collapsible ergonomic accessory 10 for attachment to a handheld electronic device 20 takes on a substantially flat form factor when the support stand 106/158 and ergonomic brace 110 are nested within a peripheral boundary 162 of the mountable base 102.

Because the ergonomic brace 110 is intended to engage with a user’s finger, the brace 110 aligns with the bottom 24 of the mobile device 20. The length of the support stand 106 is equal to a length between the mountable base 102 and the ergonomic brace element 110, whereby the mountable base 102 may be positioned a distance from a periphery 24 of the handheld electronic device 20 equal to the length of the support stand 106. The semi-circular arch of the ergonomic brace element 110 is oriented with an apex of the semi-circular arch positioned against a periphery 24 of the handheld electronic device 20, as shown in FIG. 2, when the ergonomic brace element 110 may engaged with a user’s finger.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. A collapsible ergonomic accessory for attachment to a handheld electronic device, comprising:
a mountable base;
an adhesive element affixed to an underside of said base, whereby said adhesive element couples said mountable base to a rear surface of a handheld electronic device;
a support stand pivotally connected to said mountable base by a hinge element; and
an ergonomic brace element at a distal end of said support stand, whereby said ergonomic brace element defines a semi-circular arch configured to engage with a user’s finger.

2. The collapsible ergonomic accessory for attachment to a handheld electronic device, as recited in claim 1, wherein the ergonomic brace element further comprises:
a clamp affixed to said distal end of said support stand, whereby said clamp pivotally captures a shaft at a center point of said semi-circular ergonomic brace element, wherein an engagement of said clamp and said shaft allows rotatable movement of said semi-circular ergonomic brace about an axis of said shaft thereby allowing an orientation of said semi-circular ergonomic brace element to be selected from a concave position in relation to said support stand or convex in relation to said support stand.

3. The collapsible ergonomic accessory for attachment to a handheld electronic device, as recited in claim 2, wherein the clamp and the shaft are frictionally engaged resulting in a stiff rotation, thereby allowing said orientation of said semi-circular brace to remain in position until changed by a user.

4. The collapsible ergonomic accessory for attachment to a handheld electronic device, as recited in claim 3, wherein each end of the semi-circular brace is covered with a rubber sheath, and a rubber cover envelops the clamp, thereby creating frictional pressure between each rubber sheath and said rubber cover, thereby providing frictional engagement for the semi-circular brace and cushion for a user’s finger.

5. The collapsible ergonomic accessory for attachment to a handheld electronic device, as recited in claim 2, wherein the clamp includes a threaded aperture in a surface facing said support stand to complementarily engage a threaded screw extending through said distal end of said support stand to rotatably couple said clamp to said support stand.

6. The collapsible ergonomic accessory for attachment to a handheld electronic device, as recited in claim 1, wherein the mountable base comprising:
a two-part base body, wherein a first part in said two-part base body defines a main body with hinge coupling to said support stand;
a second part of said two-part base body defining a mounting bracket with said adhesive element affixed to said underside of said base;
said second part of said two-part base body immovably affixes to said rear surface of a handheld electronic device; and
wherein once coupled together, said first part of said two-part base body may rotate about a center point of said second part of said two-part body, thereby creating a rotatable support stand for a handheld electronic device.

7. The collapsible ergonomic accessory for attachment to a handheld electronic device, as recited in claim 6, wherein said second part of said two-part base body rotatably couples to said first part by a fastener that snaps into an aperture in a center point of said first part of said two-part base body.

8. The collapsible ergonomic accessory for attachment to a handheld electronic device, as recited in claim 7, further comprising:
a rubber gasket located between said first part of said two-part base body and said second part of said two-part base body, thereby creating friction to allow the support stand to remain in a fixed position without rotating out of place.

9. The collapsible ergonomic accessory for attachment to a handheld electronic device, as recited in claim 6, wherein the first part of said two-part base body and the second part of said two-part base body are frictionally engaged resulting in a stiff rotation, thereby allowing an orientation of said first part of said two-part base body to remain in a position relative to said second part of said two-part base body until changed by a user.

10. The collapsible ergonomic accessory for attachment to a handheld electronic device, as recited in claim 1, wherein a length of said support stand is equal to a length between said mountable base and said ergonomic brace element, whereby said mountable base may be positioned a distance from a periphery of said handheld electronic device equal to the length of the support stand.

11. The collapsible ergonomic accessory for attachment to a handheld electronic device, as recited in claim 1, wherein the semi-circular arch of the ergonomic brace element is oriented with an apex of said semi-circular arch positioned against a periphery of said handheld electronic device when said ergonomic brace element is engaged with a user’s finger.

12. The collapsible ergonomic accessory for attachment to a handheld electronic device, as recited in claim 1, wherein said hinge element of said support stand includes a male hinge component of the support stand engaging with a female end of said mountable base, press-fit pin inserts through a hollow shaft on the male hinge component of the support stand so that the stand stays tight, thereby providing frictional support to keep said support stand in a constant position when engaged.

13. The collapsible ergonomic accessory for attachment to a handheld electronic device, as recited in claim 1, further comprising:
a semi-circular arch protruding from a top surface of said mountable base; and
said semi-circular arch having a gap at its apex for insertion of said hinge element.

14. The collapsible ergonomic accessory for attachment to a handheld electronic device, as recited in claim 13, wherein said support stand is a concentric ring with an open interior portion.

15. The collapsible ergonomic accessory for attachment to a handheld electronic device, as recited in claim 14, further comprising:
a raised circular plateau at a center point of said top surface of said mountable base, whereby said support stand is configured to nest in between said semi-circular arch protruding from said top surface of said mountable base and said raised circular plateau when said support stand is in a closed state.

16. The collapsible ergonomic accessory for attachment to a handheld electronic device, as recited in claim 15, wherein said ergonomic brace element is configured to nest above said support stand with a geometry completing the raised semi-circular arch protruding the top surface of the mountable base, wherein the collapsible ergonomic accessory for attachment to a handheld electronic device takes on a substantially flat form factor when the support stand and ergonomic brace are nested within a peripheral boundary of said mountable base.
